(19) United States
(12) Patent Application Publication
(10) Pub. No.: US 2024/0365815 A1
(43) Pub. Date: Nov. 7, 2024

(54) FEED ADDITIVE COMPRISING IODOFORM FOR USE IN A METHOD OF REDUCING METHANE PRODUCTION IN AND/OR FOR IMPROVING PERFORMANCE OF A RUMINANT

(71) Applicant: DANSK LANDBRUGS GROVVARESELSKAB A.M.B.A., Fredericia (DK)

(72) Inventors: Mette Olaf Nielsen, Copenhagen S (DK); Hanne Helene Hansen, Lynge (DK)

(21) Appl. No.: 18/574,957

(22) PCT Filed: Jun. 29, 2022
(86) PCT No.: PCT/EP2022/067913

§ 371 Date: Dec. 28, 2023

(30) Foreign Application Priority Data
Jun. 29, 2021 (EP) 21182396.8

(51) Int. Cl. A23K 20/105; A23K 50/10

(52) U.S. Cl. CPC A23K 20/105; A23K 50/10

(57) ABSTRACT

The present invention relates to Iodoform for use in a method of reducing methane production in and/or for improving performance of a ruminant, said method comprising the step of administering to the ruminant iodoform in an effective amount in the range of 5-100 mg of iodoform/kg DM. The present invention also relates to a method of reducing methane production in and/or for improving performance of a ruminant, and to a feed additive for a ruminant.

### FIELD OF THE INVENTION

The present invention relates to iodoform for use in a method of reducing methane production in and/or for improving performance of a ruminant. The present invention also relates to a method of reducing methane production in and/or for improving performance of a ruminant and to a feed additive for a ruminant.

### BACKGROUND OF THE INVENTION

Ruminants account for as much as 30% of global anthropogenic methane emissions or 44% of total greenhouse gas (GHG) emissions from livestock (Gerber et al. (2013); Tackling

Climate Change Through Livestock-A global assessment of emissions and mitigation opportunities. Rome: Food and Agriculture Organization of the United Nations (FAO), 2013). Methane is a GHG 25 times more powerful than CO2. There is a substantial pressure to reduce climate footprint from milk and beef production. Methane (CH4) is synthesised as follows: CO2+4H2→CH4+2H2O. Rumen archaea are the microorganisms responsible for this synthesis (Patra et al. (2017); Rumen methanogens and mitigation of methane emission by anti-methanogenic compounds and substances, J Anim Sci Biotechnol 8:13, DOI 10.1186/s40104-017-145-9). Archaea represents a distinct domain of living organisms, differing from both bacteria and eukaryotes.

Broucek, J. Options to Methane Production Abatement in Ruminants: A Review, The Journal of Animal & Plant Sciences, 28 (2): 2018, p. 348-364, analyses published data on practices that mitigate enteric methane emissions from ruminants. The study of Broucek is divided into nine sections (defaunation and inhibition of archaea, bacteriocins, methane inhibitors and analogues, probiotics, saponins, tannins, ionophores, organic acids, and lipids).

Lanigan, G. W., Metabolism of pyrrolizidine alkaloids in the ovine rumen, Aust. J. Agric. Res., (1972), 23, 1085-91 report results showing that five halogenated methane analogues (bromoform, chloroform, iodoform, carbon tetrabromide, and carbon tetrachloride) inhibit methane formation in the sheep's rumen as well as in rumen fluid in vitro.

Lanigan, G. W. et al., Antimethanogenic Drugs and Heliotropium europaeum Poisoning in Penned Sheep, Aust. J. Agric. Res., (1978), 29, 1281-92 report results showing an anti-methanogenic effect of oral dosing with iodoform pellets to sheep.

WO 2012/084629A1 relates to a method for reducing the production of methane emanating from the digestive activities of a ruminant and/or for improving ruminant animal performance by using, as an active compound, at least one organic molecule substituted at any position with at least one nitrooxy group, or a salt thereof, which is administrated to the animal together with the feed.

There is still a need for a method of reducing methane formation in and/or for improving performance of a ruminant, which provides an efficient reduction in methane formation without deleterious side-effects.

### Object of the Invention

It is an object of embodiments of the invention to provide a product for use in a method of reducing methanogenesis in and/or for improving performance of a ruminant while avoiding compromising milk production of the ruminant to any significant extent.

It is a further object of embodiments of the invention to provide a method for reducing methane production in and/or for improving performance of a ruminant.

It is a further object of embodiments of the invention to provide a feed additive for a ruminant for use for reducing methanogenesis in and/or for improving performance of said ruminant.

### SUMMARY OF THE INVENTION

It has been found by the present inventor(s) that by providing iodoform to a ruminant in an effective amount in the range of 5-100 mg/kg dry matter (DM) a reduction in methane production of at least 10% may be obtained without significantly compromising milk production of the ruminant.

So, in a first aspect the present invention relates to iodoform for use in a method of reducing methane production in and/or for improving performance of a ruminant selected from the group consisting of bovines, said method comprising the step of administering to the ruminant iodoform in an effective amount in the range of 5-100 mg/kg dry matter (DM).

In a second aspect the present invention relates to a method of reducing methane production in and/or for improving performance of a ruminant selected from the group consisting of bovines, comprising the step of administering to said ruminant iodoform in an effective amount in the range of 5-100 mg/kg dry matter (DM).

In a third aspect the present invention relates to a feed additive for a ruminant selected from the group consisting of bovines, comprising iodoform in an effective amount in the range of 5-100 mg/kg dry matter (DM).

### LEGENDS TO THE FIGURE

FIG. 1 shows the effect of different daily dosages of iodoform on A) methane (CH4) emission in L/day; and B) methane (CH4) emission per day per kg DMI;

FIG. 2 shows the effect of different daily dosages of iodoform on hydrogen (H2) emission in L/day;

FIG. 3 shows the effect of different daily dosages of iodoform on A) feed intake (dry matter intake (DMI) in kg/day); B) production of energy correlated milk (ECM; kg/day) for the experiment described in more detail in EXAMPLE 1 below; and

FIG. 4 shows hourly production of (A) methane and B) hydrogen for different dosages of iodoform for the experiment described in more detail in EXAMPLE 2 below;

FIG. 5 shows the effect of different dosages of iodoform on methane production;

FIG. 6 shows the effect of different dosages of iodoform on feed intake (Total Mixed Ration (TMR) dry matter intake (DMI);

FIG. 7 shows the methane production per kg DMI for different dosages of iodoform;

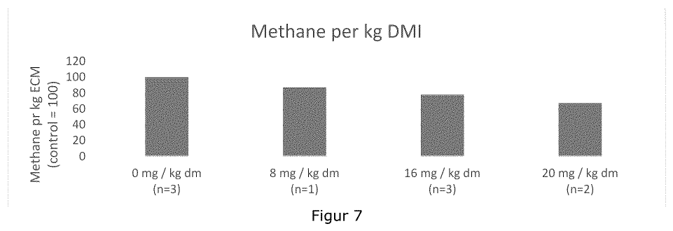

FIG. 8 shows energy corrected milk (ECM) for different dosages of iodoform; and

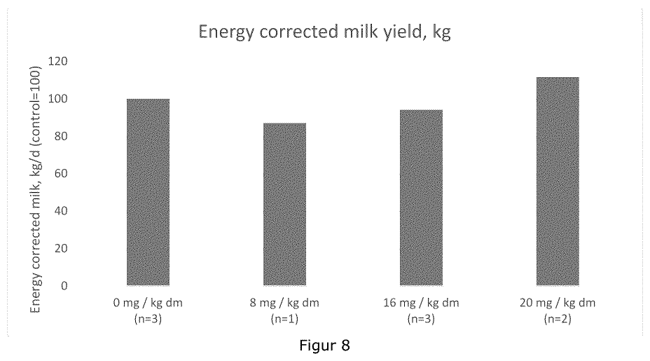

FIG. 9 shows the methane production per kg ECM for different dosages of iodoform, wherein FIG. 5-9 illustrate the experiment described in more detail in EXAMPLE 3 below.

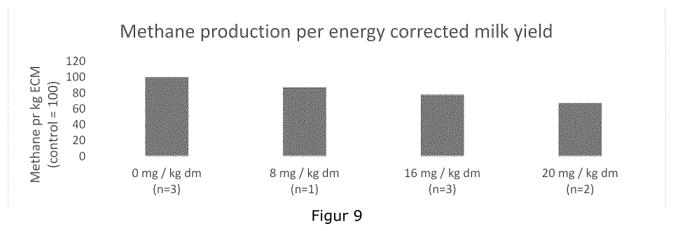

### DETAILED DISCLOSURE OF THE INVENTION

### Definitions

The term “methanogenesis”, “methane production” and “methane emission” is used interchangeably in the present context to describe the production of methane emanating from the digestive activities of ruminants.

The term “improving performance” is used in the present context to refer to improving overall performance of a ruminant in terms of e.g. feed conversion ratio and feed efficiency, such as improvement of milk yield as a function of feed intake.

The term “bovine” refers to any of a subfamily of bovinae including cattle and cows, buffaloes, bison, and other antelopes.

The term “dry matter” or “DM” is used in the present context to refer to the material remaining after all of the water is evaporated out of a feed.

### Specific Embodiments of the Invention

In an embodiment of the invention iodoform is for use in a method of reducing methane production in and/or for improving performance of a ruminant, said method comprising the step of administering to said ruminant iodoform in an amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 12-50 mg/kg DM, such as 15-50 mg/kg DM, such as an amount in the range of 15-45 mg/kg DM.

It has surprisingly been found that by administering iodoform to a ruminant at such amounts it is possible to achieve a significant reduction in methane production in said ruminant without significantly influencing milk production and/or feed intake. While a significant reduction in methanogenesis is achieved through the administration of iodoform accompanied by some or a substantial reduction in feed intake a much less pronounced reduction in milk yield is observed, and hence an improved feed conversion rate—measured as amount of milk produced per unit of ingested feed—is obtained and thereby an improved feed efficiency.

In an embodiment of the invention iodoform is to be administered to the ruminant by supplementing feed intended for said ruminant with an amount in the range of 5-100 mg of iodoform/kg DM.

In an embodiment of the invention iodoform is added to the feed intended for said ruminant. This allows a convenient method of administration of iodoform to the ruminant.

In an embodiment of the invention iodoform is to be administered to said ruminant as a bolus dose corresponding to an amount in the range of 5-100 mg of iodoform/kg DM. Thereby an efficient uptake by the ruminant is secured.

In an embodiment of the invention iodoform is for use in a method of reducing methane production in a bovine selected from the group consisting of cattle and cows, such as lactating cows.

In an embodiment of the invention iodoform is for use in a method of reducing methane production in and/or for improving performance of a ruminant, wherein the methane production, calculated in liters per kilogram of dry matter intake, is reduced by at least 10% when measured in metabolic chambers, such as wherein the methane production is reduced by at least 15%, such as at least 20%, such as at least 25%, such as at least 30%. It has surprisingly been found that by administering iodoform to a ruminant in an effective amount in the range of 5-100 mg/kg DM it is possible to achieve a substantial reduction in methane production without significantly influencing milk production of said ruminant.

Methane emission by ruminants can easily be measured in individual animals in metabolic chambers by methods known in the art, see e.g. Ding et al 2006: Chapter 10: Emissions from Livestock and Manure Management. 2006 IPCC Guidelines for National Greenhouse Gas Inventories. Volume 4: Agriculture, Forestry and Other Land Use. https://www.ipcc-nggip.iges.or.jp/public/2006gl/pdf/4.

In an embodiment of the method according to the invention said method comprises administering to the ruminant iodoform in an effective amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 10-40 mg/kg DM, such as 10-30 mg/kg DM, such as 10-25 mg/kg DM, such as 10-20 30 mg/kg DM, such as 12-50 mg/kg DM, such as 15-50 mg/kg DM, such as an amount in the range of 15-45 mg/kg DM.

In an embodiment of the method according to the invention iodoform is administered to said ruminant by supplementing feed intended for said ruminant at an amount in the range of 5-100 mg of iodoform/kg DM.

In an embodiment of the method according to the invention iodoform is supplied in pure form.

In another embodiment of the method according to the invention iodoform is administered to said ruminant as a bolus dose in an amount in the range of 5-100 mg of iodoform/kg DM.

In an embodiment of the method according to the invention iodoform is administered to a bovine selected from the group consisting of cattle and cows, such as lactating cows.

In an embodiment of the method according to the invention the methane production in ruminants, calculated in liters per kilogram of dry matter intake, is reduced by at least 10% when measured in metabolic chambers, such as wherein the methane production is reduced by at least 15%, such as at least 20%, such as at least 25%, such as at least 30%.

In an embodiment of the feed additive according to the invention, said feed additive comprises iodoform in an amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 10-40 mg/kg DM, such as 10-30 mg/kg DM, such as 10-25 mg/kg DM, such as 10-20 mg/kg DM, such as 12-50 mg/kg DM, such as 15-50 mg/kg DM, such as an amount in the range of 15-45 mg/kg DM.

As indicated above, iodoform is useful as a compound for feed additives and animal feed compositions for ruminants for reducing methane formation in and/or for improving performance of said ruminants. The feed additive or feed composition according to the invention is preferably a ruminant base mix, such as a mineral premix or a vitamin premix comprising vitamins and minerals. Vitamin and mineral premixes are designed to provide ruminants with all their nutritional needs. Non-limiting commercially available examples thereof include fat-soluble vitamins as A, D and E, trace minerals such as manganese, zinc, cobalt, iron, iodine and selenium, macro-minerals as calcium, phosphorous and sodium.

In an embodiment of the feed additive according to the invention iodoform h admixed to a total mixed ration (TMR) feed. In a TMR all dietary components, e.g. forage, silage and concentrate, are mixed before serving. Forage is a plant material, silage is grass or other green fodder made from green foliage crops which have been preserved such as by acidification, achieved through fermentation, and concentrate refers to a product mainly consisting of cereals, such as, but not limited to, barley, maize, wheat, but may also include protein-rich feed ingredients such as soybean, rapeseed, and sunflower.

Iodoform may be administered to the ruminant in different other forms. For example, iodoform may also be included in a bolus that would be placed in the rumen and that would release a defined amount of the active compound continuously in well-defined dosages over a specific period of time as known to a person skilled in the art.

Therefore, in another embodiment of the feed additive according to the invention iodoform is in the form of a bolus dose corresponding to an effective amount in the range of 5-100 mg/kg DM.

Iodoform may also be provided in encapsulated form. Encapsulation is a technique by which one material or a mixture of materials is coated with or entrapped within another material or system. Materials for encapsulation include proteins, carbohydrates, lipids, gums and cellulose. Non-limiting examples include polysaccharide, maltodextrin, corn syrup solid, modified starch, gum arabic, modified cellulose, gelatine, cyclodextrin, lecithin, whey protein, hydrogenated starch.

Non-limiting methods for encapsulation include pelleting, coacervation, spray drying, fluid bed drying, spray cooling, molecular inclusion as known to a person skilled in the art.

Iodoform may also be dissolved into a liquid solution. This liquid solution can be added to the TMR ration or through water for drinking.

In an embodiment of the feed additive for a ruminant according to the invention the ruminant is a bovine selected from the group consisting of cattle and cows, such as a lactating cow.

### Example 1

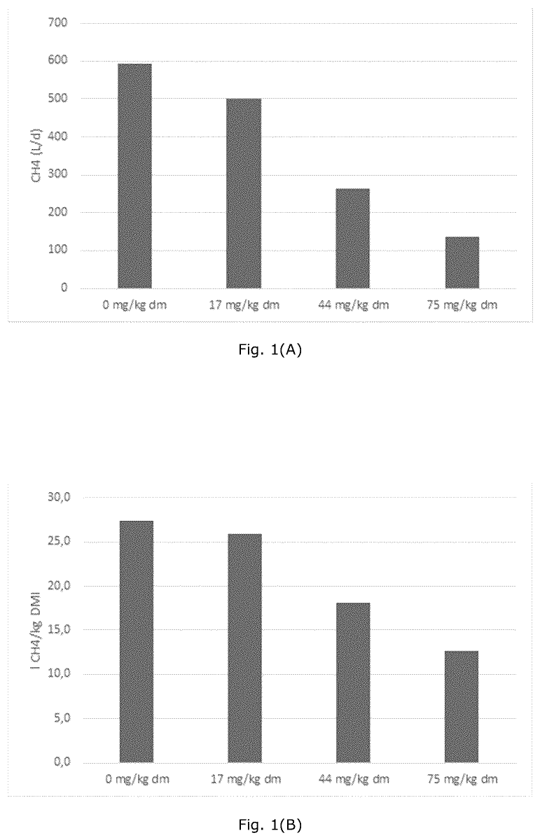

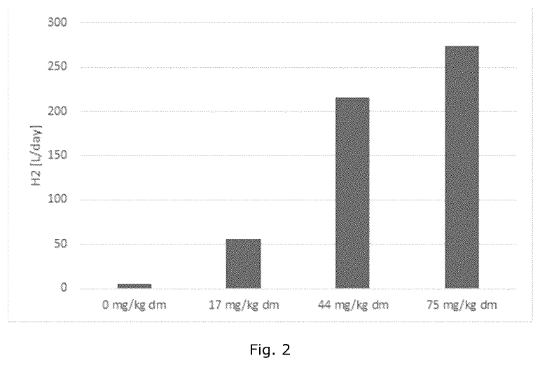

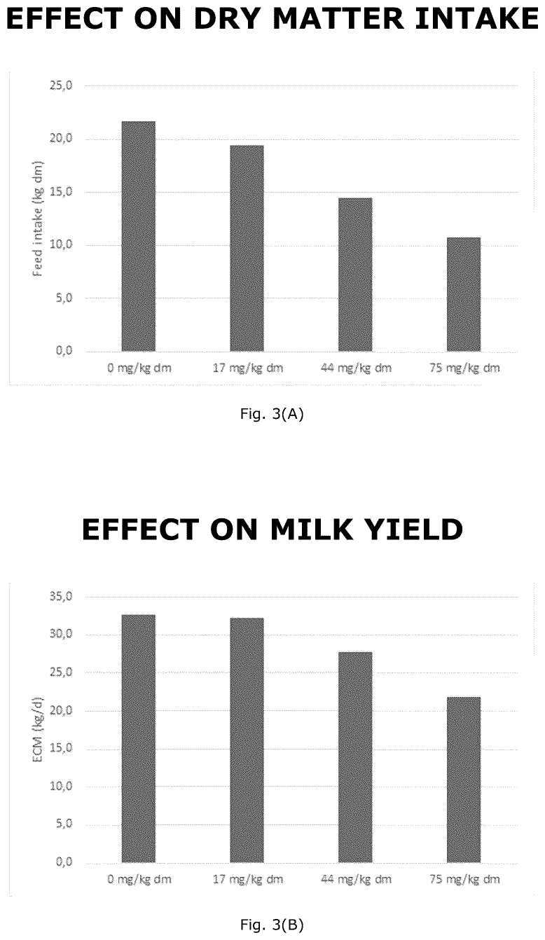

In an experiment 4 cows in each of 4 periods of 2 weeks duration were given 4 different doses of iodoform dissolved in 99% pure ethanol (0, 17, 44, and 75 mg/kg dietary DM, respectively). Measurements of gas emission in respiration chambers showed that iodoform administered as a bolus dose directly in the rumen (dosage evenly distributed over 2 daily doses) can reduce methane emission from dairy cows in a dose-response dependent manner, and by up to about 80% reduction at a total dosage of 75 mg/kg dietary DM (FIG. 1(A)). However, with such a high reduction in methane emission, there is also a substantial decrease in feed intake (about 50%, FIG. 3(A)). However, the milk yield was decreased to a much lesser extent (about 33%, FIG. 3(B)), thereby showing an improved feed efficiency. At the highest dose (75 mg/kg DM), the decrease in feed intake was accompanied by an increase of about 250 L/day or about 1400% in the excretion of hydrogen (from about 20 to about 270 L/day (FIG. 2)).

At a dose of iodoform of 44 mg/kg DM, methane emissions were reduced by about 50% (FIG. 1(A)) without significantly affecting milk yield (FIG. 3(B)), while a decrease in feed intake of about 33% (FIG. 3(A)) was observed.

### Feed Efficiency

At a given reduction of X L/d in methane emission, a 4×X L/d increase in H2 emission would be expected from the stoichiometric relationships. According to FIGS. 1 and 2, when cows were dosed with e.g. 75 mg iodoform/kg dm the decrease in methane was 456 L/day and the H2 level was therefore expected to be 1.824 L/day. However, the H2 level only increased to 269 L/day. The excess H2 is believed to have become available for retention and conversion to microbial biomass, which can flow out of the rumen and be absorbed in the small intestine, thus improving feed efficiency.

This is supported by the observation that iodoform administration decreased rumen OM digestibility of the same diet without affecting the overall total tract digestibility (Table 1).

TABLE 1
Effect of iodoform supplementation on digestibility

| | Treatments | | | | | P-values | | |
|---|---|---|---|---|---|---|---|---|
| Dose,* | 0 | 17 | 44 | 75 | SEM | Treatment | Linear effect | Quadratic effect |

Apparent rumen digestibility (%)

| | | | | | | | | |
|---|---|---|---|---|---|---|---|---|
| DM | 37.1 | 32.2 | 28.4 | 24.5 | 3.76 | 0.11 | <0.01 | 0.87 |
| OM | 46.8 | 43.2 | 40.2 | 38.3 | 2.72 | 0.14 | 0.01 | 0.99 |
| NDF | 65.5 | 69.4 | 66.5 | 65.6 | 3.81 | 0.76 | 0.95 | 0.32 |

Apparent small intestinal digestibility (%)

| | | | | | | | | |
|---|---|---|---|---|---|---|---|---|
| DM | 51.5 | 58.6 | 60.2 | 62.8 | 2.34 | 0.02 | <0.01 | 0.32 |
| OM | 48.3 | 55.7 | 57.4 | 59.5 | 2.57 | 0.03 | <0.01 | 0.31 |

Apparent large intestinal digestibility (%)

| | | | | | | | | |
|---|---|---|---|---|---|---|---|---|
| DM | 16.1 | 8.5 | 10.3 | 10.7 | 4.28 | 0.29 | 0.22 | 0.15 |
| OM | 13.33 | 4.47 | 7.21 | 8.05 | 4.32 | 0.23 | 0.28 | 0.10 |
| NDF | 17.9 | 3.01 | 4.76 | 11.5 | 5.7 | 0.09 | 0.25 | 0.02 |

Apparent total tract digestibility (%)

| | | | | | | | | |
|---|---|---|---|---|---|---|---|---|
| DM | 74.8 | 74.5 | 74.6 | 74.9 | 1.16 | 0.98 | 0.99 | 0.71 |
| OM | 76.5 | 76.1 | 76.6 | 77.0 | 1.13 | 0.91 | 0.72 | 0.54 |
| NDF | 66.3 | 65.6 | 66.9 | 69.2 | 1.52 | 0.34 | 0.20 | 0.18 |

*iodoform supplementation, mg/kg dm
OM = organic matter
NDF = neutral detergent fiber

### Example 2

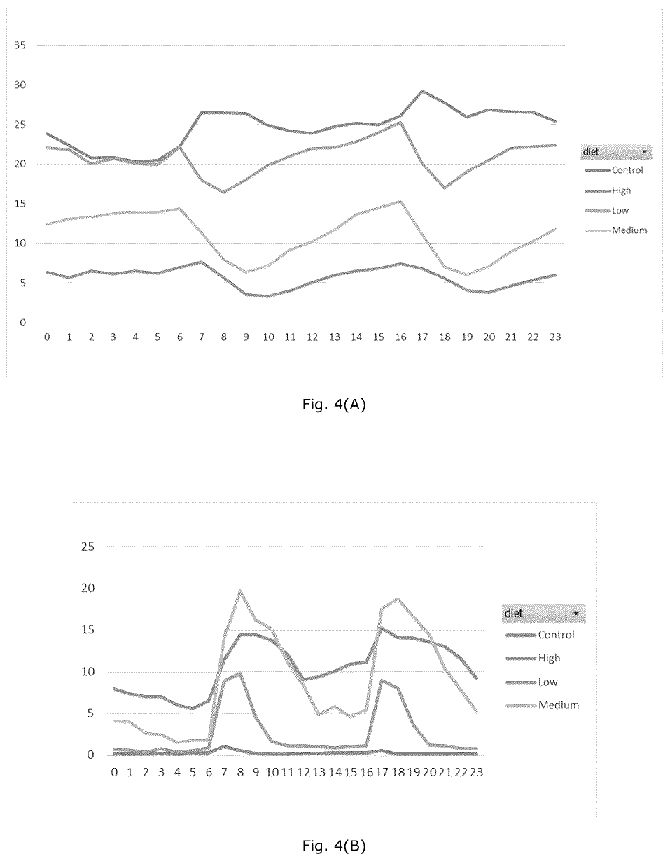

In an experiment 2 cows were supplemented with either no (control), 16 mg/kg DM (low), 44 mg/kg DM (medium) or 75 mg/kg DM of iodoform. As it appears from FIG. 4(A) the methane concentration decreased immediately after feeding for both low, medium and high dosages of iodoform followed by a slow increase until next feeding.

FIG. 4(B) shows the corresponding H2 concentration. A similar pattern is observed, however showing a more pronounced increase in H2 concentration after supplementation of iodoform, but a relatively stable H2 concentration between feedings.

### Example 3

Four lactating Holstein dairy cows was included in the trial with six doses of iodoform being 0 (negative control), 8, 16, 20, 24 and 32 mg kg DM TMR. Iodoform was used in pure form and not dissolved before use. Each treatment period lasted 14 days and control treatment was measured as a 5-day pre-period, before the trial. Measurements of gas production was conducted in respiration chambers during the last 2 days of each period along with analysis of milk composition. During the first period cows receiving 24 and 32 mg iodoform/kg TMR DM reduced their feed intake after 4-7 days of adding iodoform to the feed ration. Administration of iodoform was stopped for these doses after 13 days. Results from the cow receiving 24 mg iodoformkg TMR DM were omitted from the results caused by adverse effects on production through the experimental trial. All results are expressed relative to observations in the control group (Methane production: 558.7 L/day, feed intake: 23.5 kg dm, energy corrected milk: 38.03 kg/day, methane production pr kg dry matter intake: 23.91 L/kg dm, methane production pr kg energy corrected milk: 15.74 kg.

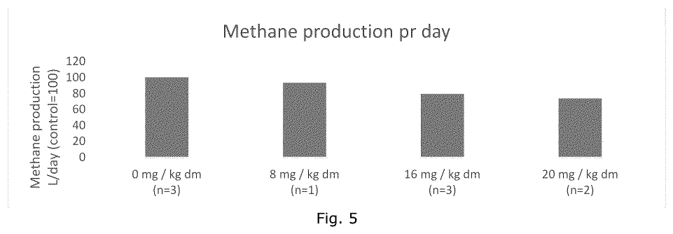

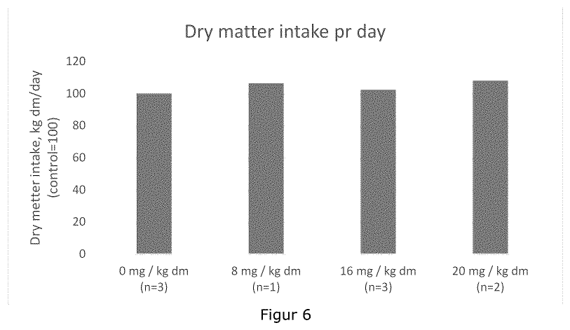

The results showed that a pure form of iodoform was able to reduce the methane production. The methane production decreased with higher supplementation rate of iodoform (FIGS. 5 & 7). Methane production pr kg dm was reduced 11%, 21% and 29% when supplemented 8 mg/kg dm, 16 mg/kg dm and 20 mg/kg dm of iodoform, respectively. The feed intake and milk yield were largely unaffected of iodoform supplementation up to 20 mg/kg dm (FIGS. 6 & 8) but were decreased at supplementation rates of 24 mg/kg dm and 32 mg/kg dm (results not shown).

### List of References

Lanigan, G. W., Metabolism of pyrrolizidine alkaloids in the ovine rumen, Aust. J. Agric. Res., (1972), 23, 1085-91
Lanigan, G. W. et al., Antimethanogenic Drugs and Heliotropium europaeum Poisoning in Penned Sheep, Aust. J. Agric. Res., (1978), 29, 1281-92
Gerber et al. (2013); Tackling Climate Change Through Livestock-A global assessment of emissions and mitigation opportunities. Rome: Food and Agriculture Organization of the United Nations (FAO), 2013
Kamra D N et al.: “Manipulation of Rumen Microbial Ecosystem for Reducing Enteric Methane Emission in Livestock”, Climate Change Impact on Livestock: Adaptation and Mitigation, 1 Jan. 2015, p. 255-272, XP009531560, DOI: 10.1007/978-81-322-2265-1_16 ISBN: 978-81-2265-1
Patra et al. (2017); Rumen methanogens and mitigation of methane emission by anti-methanogenic compounds and substances, J Anim Sci Biotechnol 8:13, DOI 10.1186/s40104-017-145-9
Broucek, J. Options to Methane Production Abatement in Ruminants: A Review, The Journal of Animal & Plant Sciences, 28 (2): 2018, p. 348-364
AU 2018 229 465 A1
WO 2012/084629A1

1. Iodoform for use in a method of reducing methane production in and/or for improving performance of a ruminant selected from the group consisting of bovines, said method comprising the step of administering to the ruminant iodoform in an effective amount in the range of 5-100 mg/kg dry matter (DM).

2. Iodoform for the use according to claim 1, comprising the step of administering to said ruminant iodoform in an amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 10-40 mg/kg DM, such as 10-30 mg/kg DM, such as 10-25 mg/kg DM, such as 10-20 mg/kg DM, such as 12-50 mg/kg DM, such as 15-50 mg/kg DM, such as an amount in the range of 15-45 mg/kg DM.

3. Iodoform for the use according to any one of the preceding claims, wherein improving performance of a ruminant comprises improving feed efficiency in the form of milk yield per unit of ingested feed.

4. Iodoform for the use according to any one of the preceding claims, wherein said iodoform is to be administered to said ruminant by supplementing feed intended for said ruminant with an amount in the range of 5-100 mg of iodoform/kg DM or as a bolus dose corresponding to an amount in the range of 5-100 mg of iodoform/kg DM.

5. Iodoform for the use according to any one of the preceding claims, wherein said bovine is selected from the group consisting of cattle and cows, such as lactating cows.

6. Iodoform for the use according to any one of the preceding claims, wherein the methane production in a ruminant, calculated in liters per kilogram of dry matter (DM), is reduced by at least 10% when measured in metabolic chambers, such as wherein the methane production is reduced by at least 15%, such as at least 20%, such as at least 25%, such as at least 30%.

7. A method of reducing methane production in and/or for improving performance of a ruminant selected from the group consisting of bovines, comprising the step of administering to said ruminant iodoform in an effective amount in the range of 5-100 mg of iodoform/kg DM.

8. The method according to claim 7, said method comprising administering to the ruminant iodoform in an effective amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 10-40 mg/kg DM, such as 10-30 mg/kg DM, such as 10-25 mg/kg DM, such as 10-20 mg/kg DM, such as 12-50 mg/kg DM, such as 15-50 mg/kg DM, such as an amount in the range of 15-45 mg/kg DM.

9. The method according to any one of claims 7-8, wherein said iodoform is administered to said ruminant by supplementing feed intended for said ruminant with an amount in the range of 5-100 mg of iodoform/kg DM or as a bolus dose in an amount corresponding to the range of 5-100 mg of iodoform/kg DM.

10. The method according to any one of claims 7-9, wherein the bovine is selected from the group consisting of cattle and cows, such as a lactating cow.

11. The method according to any one of claims 7-10, wherein the methane production in the ruminant animal, calculated in liters per kilogram of dry matter, is reduced by at least 10% when measured in metabolic chambers, such as wherein the methane production is reduced by at least 15%, such as at least 20%, such as at least 25%, such as at least 30%.

12. A feed additive for a ruminant comprising iodoform in an effective amount in the range of 5-100 mg of iodoform/kg DM.

13. The feed additive according to claim 12, comprising iodoform in an amount in the range of 5-90 mg/kg DM, such as 5-80 mg/kg DM, such as 5-70 mg/kg DM, such as 5-60 mg/kg DM, such as 7-60 mg/kg DM, such as 10-60 mg/kg DM, such as 10-55 mg/kg DM, such as 10-50 mg/kg DM, such as 10-40 mg/kg DM, such as 10-30 mg/kg DM, such as 10-25 mg/kg DM, such as 10-20 mg/kg DM, such as 12-50 mg/kg DM, such as 15-50 mg/kg DM, such as an amount in the range of 15-45 mg/kg DM.

14. The feed additive according to any one of claims 12-13, wherein iodoform has been admixed to a total mixed ration (TMR) feed.

15. The feed additive according to any one of claims 12-13, wherein iodoform is in the form of a bolus dose in an effective amount corresponding to a range of 5-100 mg of iodoform/kg DM.

16. The feed additive according to any one of claims 12-15, wherein the ruminant is a bovine selected from the group consisting of cattle and cows, such as a lactating cow.
